(19) United States
(12) Patent Application Publication
(10) Pub. No.: US 2026/0149294 A1
(43) Pub. Date: May 28, 2026

(54) BATTERY BALANCING SYSTEM AND OPERATING SYSTEM THEREOF

(71) Applicant: ELECTRONICS AND TELECOMMUNICATIONS RESEARCH INSTITUTE, Daejeon (KR)

(72) Inventors: Yil Suk YANG, Daejeon (KR); YOUNG SAM PARK, Daejeon (KR); Young-Gi LEE, Daejeon (KR)

(21) Appl. No.: 19/291,717

(22) Filed: Aug. 6, 2025

(30) Foreign Application Priority Data
Nov. 28, 2024 (KR) 10-2024-0173757

(51) Int. Cl. H02J 7/00

(52) U.S. Cl. CPC H02J 7/56; H02J 7/80; H02J 7/94; H02J 7/96; H02J 7/977

(57) ABSTRACT

A battery balancing system includes a battery pack block configured in rows and columns of batteries, a balancing block with balancing devices corresponding to the batteries, a balancing control block with control circuits that selectively connect batteries and balancing devices to perform balancing. The control circuits enable connections between a battery and its corresponding or adjacent balancing devices, or between adjacent batteries and corresponding balancing devices, based on control signals. The system further includes a state determination block that determines the state of batteries on a column basis, and a system controller that activates selected rows and controls the balancing connections based on the state determination result.

### CROSS-REFERENCE TO RELATED APPLICATION(S)

This application claims priority under 35 U.S.C. § 119 to Korean Patent Application No. 10-2024-0173757 filed on Nov. 28, 2024, in the Korean Intellectual Property Office, the disclosures of which are incorporated by reference herein in their entireties.

### BACKGROUND

### 1. Field of the Invention

Embodiments of the present disclosure described herein relate to a battery, and more particularly, relate to a battery balancing system and an operating method thereof.

### 2. Description of Related Art

A battery pack comprising a series and parallel combinations of a plurality of battery cells is utilized in various application fields such as electric vehicles and energy storage systems. Battery balancing means a process in which the battery pack system monitors the voltage, current, and temperature of the battery cells and compensates for voltage, current, and temperature deviations among the battery cells. Battery balancing is important to optimize the performance and lifespan of the battery pack.

Balancing methods used in the battery pack are generally classified into a passive balancing method, which releases excess energy as heat to balance with other cells, and an active balancing method, which transfers energy to a cell with less energy for reuse.

Balancing for battery modules and battery cells included in the battery pack is sequentially performed. As the number of battery cells included in the battery pack increases, the capacity of the battery pack increases, but the time required for the battery balancing may also increase.

### SUMMARY

Embodiments of the present disclosure provide a battery balancing system capable of reducing the balancing time.

A battery balancing system according to an embodiment of present disclosure comprises a battery pack block including a plurality of batteries corresponding to a plurality of rows and a plurality of columns, a balancing block including a plurality of balancing devices, each of the plurality of balancing devices corresponding to each of the plurality of batteries, and performing balancing for a connected battery among the plurality of batteries, a balancing control block including a plurality of control circuits, each of the plurality of control circuits corresponding to each of the plurality of batteries and each of the plurality of balancing devices, each of the control circuits connecting the corresponding battery and the corresponding balancing device in response to a first balancing control signal, connecting the corresponding battery and an adjacent balancing device in response to a second balancing control signal, and connecting an adjacent battery and the corresponding balancing device in response to a third balancing control signal, a battery state determination block including a plurality of state determination devices, each of the state determination devices corresponding to each of the plurality of columns and generating a state determination result based on an output signal of the corresponding column, and a system controller configured to activate a selected row among the plurality of rows and output the first to third balancing control signals corresponding to each of the plurality of batteries based on the state determination result, wherein the adjacent balancing device corresponds to the same row as the corresponding battery and corresponds to an adjacent column, and the adjacent battery device corresponds to the same row as the corresponding battery and corresponds to an adjacent column.

The operating method of the battery balancing system according to an embodiment of the present disclosure, in a battery balancing system including a plurality of batteries corresponding to a plurality of rows and a plurality of columns, comprises selecting a first row as a target row from among the plurality of rows, measuring physical quantities of batteries corresponding to the target row, determining whether the batteries corresponding to the target row are normal or abnormal based on the physical quantities of the batteries and reference values, performing multi-cell balancing according to whether one or more of the batteries corresponding to the target row are abnormal, determining whether the target row is the last row, and selecting a next row as the target row in response to the determination that the target row is not the last row, wherein the step of performing the multi-cell balancing may comprise performing self-balancing, performing first adjacent balancing, and performing second adjacent balancing.

### BRIEF DESCRIPTION OF THE DRAWINGS

The above and other objects and features of the present disclosure will become apparent by describing in detail embodiments thereof with reference to the accompanying drawings.

FIG. 1 is a block diagram illustrating a battery balancing system according to an embodiment of the present disclosure.

FIG. 2 is a detailed block diagram of the battery balancing system according to an embodiment of the present disclosure.

FIG. 3 is a circuit diagram illustrating the battery balancing system shown in FIG. 2.

FIG. 4 is a timing diagram regarding signals of the battery balancing system according to an embodiment of the present disclosure.

FIG. 5 is a flowchart illustrating an operating method of the battery balancing system according to an embodiment of the present disclosure.

### DETAILED DESCRIPTION OF THE INVENTION

Hereinafter, embodiments of the present disclosure will be described in a clear and detailed manner to the extent that a person skilled in the art can easily implement the present disclosure.

The components described with reference to the terms “unit”, “module”, “block”, “or”, “er”, and the like used in the detailed description and the functional blocks illustrated in the drawings may be implemented in the form of software, hardware, or a combination thereof. Illustratively, the software may be machine code, firmware, embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, or a combination thereof.

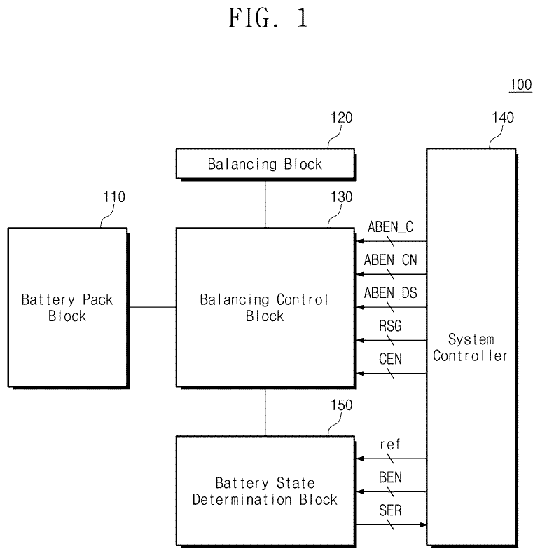

FIG. 1 is a block diagram illustrating a battery balancing system according to an embodiment of the present disclosure.

Referring to FIG. 1, the battery balancing system 100 may include a battery pack block 110, a balancing block 120, a balancing control block 130, a system controller 140, and a battery state determination block 150.

The battery balancing system 100 may perform multi-cell balancing on the batteries included in the battery pack block 110.

The plurality of batteries included in the battery pack block 110 may correspond to a battery cell or a battery module. The battery pack block 110 may be configured in levels of battery cells, battery modules, and battery packs, but may also have a cell-to-pack structure in which the module level is omitted.

The battery pack block 110 may include the plurality of batteries corresponding to a plurality of rows and a plurality of columns. For example, the plurality of batteries may correspond to M rows and N columns. That is, the plurality of batteries may have a connection structure of a matrix corresponding to M rows and N columns. One column may correspond to M batteries, and one row may correspond to N batteries. Batteries corresponding to the same column may be connected in series, and each column may be connected parallel in the row direction. That is, the battery pack block 110 may have a mixed series-parallel connection structure.

However, without being limited thereto, the plurality of batteries may be included in the battery pack block 110, and the number of batteries may also be different from each other. For example, the number of batteries included in each of the M rows of the battery pack block 100 may be different from each other. Hereinafter, for ease of understanding, it is assumed that the battery pack block 110 is configured with batteries corresponding to M rows and N columns.

The balancing block 120 may perform balancing on the battery pack block 110. The balancing may be to adjust the charge amount of a particular battery.

In one embodiment, the balancing may be performed on a battery when the output voltage of the particular battery differs by a certain magnitude or more from a reference value. The balancing may be performed on a battery when the output current of the specific battery differs by a certain amount or more from a reference value, or when the surface temperature of the specific battery varies by a certain amount of more than a reference value.

In other embodiment, the balancing may be performed on a particular battery if the charge amount of the particular battery differs from that of adjacent batteries by more than a predetermined threshold. Likewise, the balancing may also be performed if the output current of the particular battery differs from that of adjacent batteries by more than a certain threshold, or if the surface temperature of the particular battery differs from that of adjacent batteries by more than a specified threshold.

The balancing block 120 may include a plurality of balancing devices. Each of the plurality of balancing devices may correspond to each of the plurality of batteries included in the battery pack block 110. Each of the balancing devices may perform balancing on a connected battery of the plurality of batteries.

When the battery pack block 110 includes batteries of M×N, the balancing block 120 may include a plurality of balancing devices of M×N corresponding to M rows and N columns.

Each of the plurality of balancing devices may correspond one-to-one with the batteries. For example, the battery in the first row and the first column may correspond to the balancing device in the first row and the first column, and the battery in the second row and the first column may correspond to the balancing device in the second row and the first column.

The balancing control block 130 may control the connection between the plurality of batteries included in the battery pack block 110 and the balancing devices included in the balancing block 120.

The balancing control block 130 may include a plurality of control circuits corresponding to each of the plurality of batteries and each of a plurality of balancing devices. When the battery pack block 110 includes batteries of M×N and the balancing block 120 includes balancing devices of M×N, the balancing control block 130 may include control circuits of M×N.

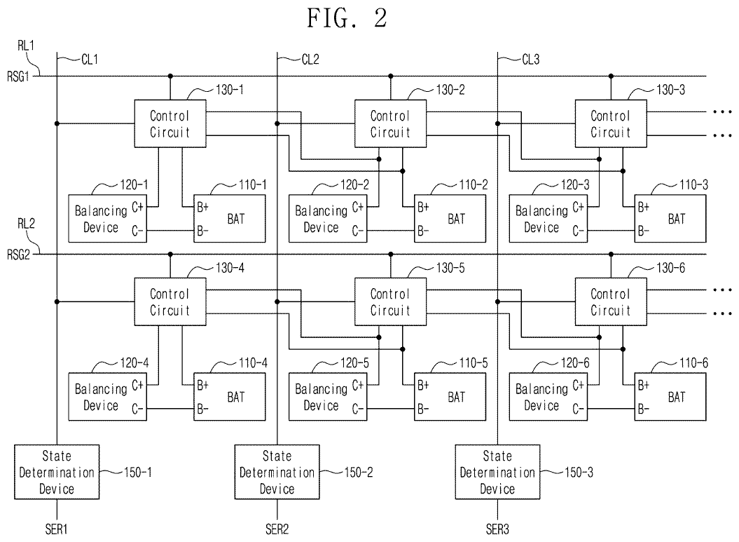

The control circuits may connect the batteries and the balancing devices in response to balancing control signals. For example, the specific control circuit may connect a battery corresponding to the specific control circuit and a balancing device corresponding to the specific controller circuit, in response to a first balancing control signal ABEN_C. The specific control circuit may connect a battery corresponding to the specific control circuit and a balancing device adjacent to the specific control circuit, in response to a second balancing control signal ABEN_CN. The specific control circuit may connect a battery adjacent to the specific control circuit and a balancing device corresponding to the specific control circuit, in response to a third balancing control signal ABEN_DS. Each of the plurality of control circuits may change the connection between the batteries and the balancing devices according to the balancing control signals. Hereafter, a battery corresponding to the specific control circuit may be simply called as a corresponding battery, a battery adjacent to the specific control circuit may be simply called as an adjacent battery, a balancing device corresponding to the specific control circuit may be simply called as a corresponding balancing device, and a balancing device adjacent to the specific control circuit may be simply called as an adjacent balancing device. The term “adjacent” does not necessarily mean being physically placed next to each other. Instead, “adjacent” may include being electrically connected. Adjacent elements may be disposed in physical proximity to each other; however, other elements may be disposed between the adjacent elements. The meanings of “corresponding one and adjacent one” may be more clearly understood with the following description referring to FIG. 2 to 5.

The system controller 140 may send control signals to the balancing control block 130.

The system controller 140 may output first to third balancing control signals ABEN_C, ABEN_CN, and ABEN_DS for each of the plurality of control circuits. The first balancing control signal ABEN_C is a signal for performing balancing between the corresponding battery and the balancing device. The second balancing control signal ABEN_CN is a signal for performing balancing between a corresponding battery and an adjacent balancing device. The third balancing control signal ABEN_DS is a signal for performing balancing between an adjacent battery and a corresponding balancing device. The system controller 140 may perform multi-cell balancing by sequentially outputting the first to third balancing control signals ABEN_C, ABEN_CN, and ABEN_DS for a specific row that needs the balancing.

The battery state determination block 150 may include a plurality of state determination devices that generate a state determination result RES based on the output signal of the corresponding column. The plurality of state determination devices may correspond to the plurality of columns, respectively. For example, when the battery pack block 110 includes batteries of M×N, the battery state determination block 150 may include N state determination devices corresponding to the N columns, respectively.

The system controller 140 may output a row selection signal RSG and an output selection signal CEN to determine the states of the batteries. The control circuit may activate the corresponding row based on the row selection signal RSG, and may select the output of the corresponding battery based on the output selection signal CEN.

The state determination devices may determine the states of the batteries based on the output signal of the row activated by the row selection signal RSG. For example, when the first row is activated, the state determination device corresponding to the first column may determine the state of the battery corresponding to the first row and the first column, based on the output signal of the first column. When the second row is activated, the state determination device corresponding to the first column may determine the state of the battery corresponding to the second row and the first column, based on the output signal of the first column. The plurality of state determination devices may provide a state determination result SER to the system controller 140.

The system controller 140 may provide a reference state information ref to the battery state determination block 150. The reference state information ref may include information about a reference voltage, a reference current, or a reference temperature. The state determination device included in the battery state determination block 150 may compare the output signal output through the balancing control block 130 with the reference state information ref to determine the state of the battery. The state determination device may provide the state determination result SER to the system controller 140 based on the comparison result.

The system controller 140 may provide the reference state selection signal BEN to the battery state determination block 150. The state determination device may determine a reference for determining the state of the battery according to the reference state selection signal BEN. For example, the state determination device may compare the voltage of the battery with the reference voltage when the reference selection signal BEN has a first value, may compare the current of the battery with the reference current when the reference selection signals BEN have a second value, and may compare the temperature of the battery with the reference temperature when the reference selection signaling BEN has a third value. The state determination device may generate the state determination result SER of the battery based on each comparison result.

The system controller 140 may output the first to third balancing control signals ABEN_C, ABEN_CN, and ABEN_DS for performing balancing on the plurality of batteries based on the state determination result SER. For example, when the state of any one of the batteries corresponding to the selected row is abnormal, the system controller 140 may output the first to third balancing control signals ABEN_C, ABEN_CN, and ABEN_DS to perform multi-cell balancing. When the batteries corresponding to the selected row are normal, the system controller 140 may skip balancing without outputting the first to third balancing control signals ABEN_C, ABEN_CN, and ABEN_DS. The system controller 140 may activate the next row to determine the states of the batteries.

FIG. 2 is a detailed block diagram of the battery balancing system according to an embodiment of the present disclosure.

Referring to FIG. 2, each of the plurality of batteries 110-1 to 110-6 may correspond to a first to a second row and a first to a third column. For example, the battery 110-1 may correspond to the first row and the first column, the battery 110-2 may correspond to the first row and the second column, and the battery 110-3 may correspond to the first row and the third column. Each of the batteries 110-4 to 110-6 may correspond to the first column, the second column, and the third column of the second row, respectively.

Each of the plurality of balancing devices 120-1 to 120-6 may correspond to a respective one of the plurality of batteries 110-1 to 110-6.

Each of the plurality of control circuits 130-1 to 130-6 may correspond to a respective one of the plurality of batteries 110-1 to 110-6 and a respective one of the plurality of balancing devices 120-1 to 120-6, respectively.

Each of the plurality of control circuits 130-1 to 130-6 may connect the plurality of batteries 110-1 to 110-6 and the plurality of balancing devices 120-1 to 120-6. For example, the control circuit 130-1 may connect the battery 110-1 and the balancing device 120-1. The control circuit 130-1 may connect the battery 110-1 and the balancing device 120-2. The control circuit 130-1 may connect the battery 110-2 and the balancing device 120-1.

A C-terminal of each of the plurality of balancing devices 120-1 to 120-6 may be connected to a B− terminal of a corresponding one of the plurality of batteries 110-1 to 110-6. The plurality of control circuits 130-1 to 130-6 may connect C+ terminals of the plurality of balancing devices 120-1 to 120-6 and B+ terminals of the plurality of batteries 110-1 to 110-6.

For example, the control circuit 130-1 may connect the B+ terminal of the battery 110-1 and the C+ terminal of the balancing device 120-1 according to the first balancing control signal. The control circuit 130-1 may connect the B+terminal of the battery 110-1 and the C+ terminal of the balancing device 120-2 according to the second balancing control signal. The control circuit 130-1 may connect the B+ terminal of the battery 110-2 and the C+ terminal of the balancing device 120-1 according to the third balancing control signal.

Similarly, the control circuit 130-2 may connect the B+terminal of the battery 110-2 and the C terminal of the balancing device 120-2, connect the B+ terminal of the battery 110-2 and the C+ terminal of the balancing device 120-3, or connect the B+ terminal of the battery 110-3 and the C+ terminal of the balancing device 120-2, according to the first to third balancing control signals.

The plurality of control circuits 130-1 to 130-6 may connect the plurality of batteries 110 to 110-6 and the column lines CL1, CL2, and CL3 according to the output selection signal CEN. The plurality of batteries 110-1 to 110-6 may output data according to the output selection signal. The output data may include at least one of a voltage, a current, or a temperature of the battery. The voltage, current, and temperature of the battery may be obtained through a sensor (not shown) provided in each of the plurality of batteries 110 to 110-6. The sensor may include a voltage sensor to sense a voltage of a corresponding battery, a current sensor to sense a current of the corresponding battery, and a temperature sensor to sense a surface temperature of the corresponding battery. The output data of each of the plurality of batteries 110-1 to 110-6 may be generated through measurement of the sensor. The plurality of batteries 110-1 to 110-6 may be provided with the output data in a corresponding column line. For example, the first row may be activated according to the row selection signal RSG1, and the battery 110-1 and the column line CL1 may be connected to each other according to the output selection signal. The output data of the battery 110-1 may be transferred to the state determination device 150-1 through the column line CL1.

Each of the plurality of state determination devices 150-1, 150-2, and 150-3 may be connected to a corresponding one of the corresponding column lines CL1, CL2, and CL3. For example, the state determination device 150-1 may be connected to the column line CL1, the state determination device 130-2 may be connected to a column line CL2, and the state determination device 140-3 may be connected to column line CL3. Each of the plurality of state determination devices 150-1, 150-2, and 150-3 may determine the state of the battery based on an output signal of each of the column lines CL1, CL2, and CL3.

For example, the first row is activated according to the row selection signal RSG1, and the output data of the battery 110-1 is transmitted to the battery state determination device 150-1 through the column line CL1 according to the output selection signal. The state determination device 150-1 may determine the state of the battery 110-1 based on the output data, and may output a state determination result SER1. When the second row is activated according to the row selection signal RSG2, the state determination device 150-1 may determine the state of the battery 110-4 and output the state determination result SER1.

The state determination device 150-2 may determine the state of the battery 110-2 or the battery 110-5 according to an activated row, and the state determination device 150-3 may determine the state the battery 110-3 or the battery 110-6 according to an activated row.

The state determination results SER1, SER2, and SER3 output from the plurality of state determination devices 150-1, 150-2, and 150-3 may be provided to the system controller 140 of FIG. 1. The system controller 140 may check whether the states of the batteries in the activated row are normal or abnormal based on the state determination results SER1, SER2, and SER3.

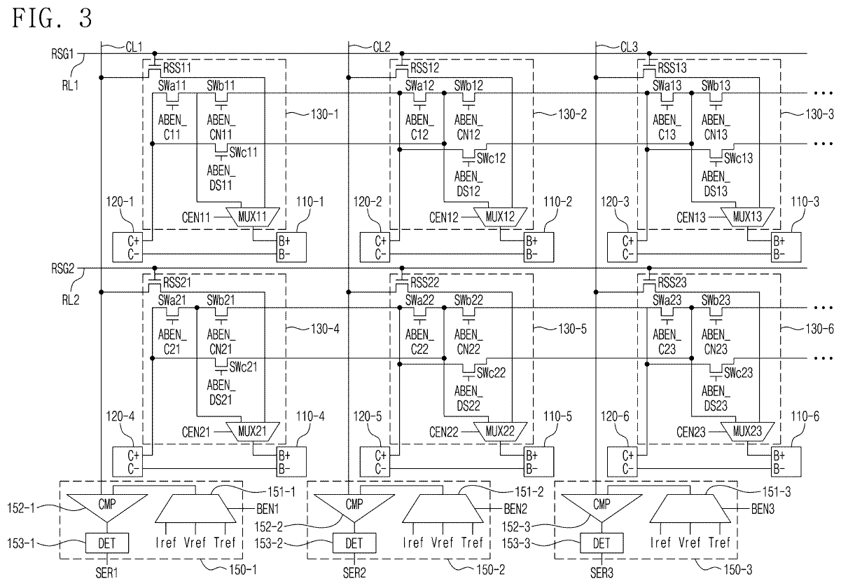

FIG. 3 is a circuit diagram illustrating the battery balancing system shown in FIG. 2.

Referring to FIG. 3, each of the plurality of control circuits 130-1 to 130-6 may include a corresponding row selection switch, a multiplexer, and first to third balancing switches.

With reference to the control circuit 130-1, the battery 110-1 and the balancing device 120-1 correspond to the control circuit 130-1, and the battery 110-2 and the balance device 120-2 are adjacent to the control circuit 130-1. With reference to the control circuit 130-2, the battery 110-2 and the balancing device 120-2 correspond to the control circuit 130-2, and the battery 110-3 and the balance device 120-3 are adjacent to the control circuit 130-2.

With reference to the control circuit 130-4, the battery 110-4 and the balancing device 120-4 correspond to the control circuit 130-4, and the battery 110-5 and the balance device 120-5 are adjacent to the control circuit 130-4. With reference to the control circuit 130-5, the battery 110-5 and the balancing device 120-5 correspond to the control circuit 130-5, and the battery 110-6 and the balance device 120-6 are adjacent to the control circuit 130-5.

The control circuit 130-1 may include a multiplexer MUX11. The multiplexer MUX11 may receive an input from the battery 110-1. The multiplexer MUX11 may output the input from the battery to either a first output or a second output in response to the output selection signal CEN11. For example, when the output selection signal CEN11 has a first selection value, the input from the battery 110-1 may be output to the first output. When the output selection signal CEN11 has a second selection value, the input from the battery 110-1 may be output to the second output. In other words, the multiplexer MUX11 may selectively connect the battery 110-1 to either the first output or the second output.

Similarly, the control circuits 130-2 to 130-6 may receive an input from the batteries 110-2 to 120-6, and output to either the first output or the second output in response to the respective output selection signals CEN12 to CEN23.

The control circuit 130-1 may include a row selection switch RSS11. The row selection switch RSS11 may be implemented as a MOSFET transistor. The row selection switch RSS11 may connect the first output of the multiplexer MUX11 and the column line CL1. The row selection switch RSS11 is turned on in response to the row selection signal RSG1 applied to the row line RL1. The control circuit 130-2 may include a row selection switch RSS12, and the control circuit 130-3 may include a row selection switch RSS13. The row selection switches RSS12 and RSS13 are turned on by the row selection signal RSG1. That is, the first row may be activated by the row selection signal RSG1. The row selection switches RSS11, RSS12, and RSS13 of the control circuits 130-1, 130-2, and 130-3 corresponding to the first row may turn on by the row selection signal RSG1.

When the first row is activated by the row selection signal RSG1 and the output selection signals CEN11, CEN12, and CEN13 have the first selection value, the input from the batteries 110-1, 110-2, and 110-3 (i.e., the output data of the batteries) may be transferred to the respective state determination devices 150-1, 150-2, and 150-3 through the respective column lines CL1, CL2, and CL3.

The row selection switches RSS21, RSS22, and RSS23 of the control circuits 130-4, 130-5, and 130-6 corresponding to the second row may be turned on by the row selection signal RSG2.

When the second row is activated by the row selection signal RSG2 and the output selection signals CEN21, CEN22, and CEN23 have the first selection value, the input (output data of the batteries) from the batteries 110-4, 110-5, and 110-6 may be transferred to the respective state determination devices 150-1, 150-2, and 150-3 through the respective column lines CL1, CL2, and CL3.

The control circuit 130-1 may include a first balancing switch SWa11, a second balancing switch SWb11, and a third balancing switch SWc11. The first balancing switch SWa11 may connect the balancing device 120-1 and the second output of the multiplexer MUX11, and is turned on in response to the first balancing control signal ABEN_C11. The second balancing switch SWb11 may connect the second output of the multiplexer MUX11 and the balancing device 120-2, and is turned on in response to the second balancing control signal ABEN_CN11. The third balancing switch SWc11 may connect the second output of a multiplexer MUX12 (of the control circuit 130-2) and the balancing device 120-1, and is turned on in response to the third balancing control signal ABEN_DS11.

When the output selection signal CEN11 has the second selection value and the first balancing switch SWa11 is activated by the first balance control signal ABEN_C11, the battery 110-1 and the balancing device 120-1 are connected. At this time, the balancing device 120-1 may perform balancing on the battery 110-1. When the output selection signal CEN11 has the second selection value and the second balancing switch SWb11 is activated by the second balancing control signal ABEN_CN11, the battery 110-1 and the adjacent balancing device 120-2 are connected. At this time, the adjacent balancing device 120-2 may perform balancing on the battery 110-1.

When the output selection signal CEN12 has the second selection value and the third balancing switch SWc11 is activated by the third balance control signal ABEN_DS11, the battery 110-2 and the balancing device 120-1 are connected. At this time, the balancing device 120-1 may perform balancing on the adjacent battery 110-2.

The control circuit 130-2 may include the multiplexer MUX12, a row selection switch RSS12, a first balancing switch SWa12, a second balancing switch SWb12, and a third balancing switch SWc12. The multiplexer MUX12 is connected to the battery 110-2, and may select the first output or the second output according to the output selection signal CEN12.

The row selection switch RSS12 may connect the column line CL2 and the first output of the multiplexer MUX12. The row selection switch RSS12 is turned on in response to the row selection signal RSG1 applied to the row line RL1.

The first balancing switch SWa12 may connect the balancing device 120-2 and the second output of the multiplexer MUX12. The first balancing switch SWa12 is turned on in response to the first balancing control signal ABEN_C12. The second balancing switch SWb12 may connect the adjacent balancing device 120-3 and the second output of the multiplexer MUX12. The second balancing switch SWb12 is turned on in response to the second balancing control signal ABEN_CN12. The third balancing switch SWc12 may connect the second output of the multiplexer MUX13 and the control circuit 130-3 adjacent to the balancing device 120-2. The third balancing switch SWc12 is turned on in response to the third balancing control signal ABEN_DS12.

The plurality of control circuits 130-1 to 130-6 may provide a connection path between the various batteries and the balancing devices. Thereby, when balancing is performed on the batteries corresponding to the activated row, the balancing can be performed not only between the batteries and the balancing devices corresponding to itself, but also between the batteries and the balancing devices adjacent to each other. Such a balancing method may be referred to as multi-cell balancing. The battery system 100 can shorten the balancing time by performing multi-cell balancing, and can provide an excellent battery pack scalability.

Each of the state determination devices 150-1, 150-2, and 150-3 may include a corresponding multiplexer, comparator, and determiner.

For example, the state determination device 150-1 may include a multiplexer 151-1. A plurality of input values may be input to multiplexer 151-1, and the multiplexer 151-1 may output one of the plurality of input values according to a reference state selection signal BEN1. For example, the multiplexer 151-1 may output a first input value among the plurality of input values based on the value of the reference state selection signal BEN1 having the first value. The multiplexer 151-1 may output a second input value among the plurality of input values based on the value of the reference state selection signal BEN1 having the second value. The multiplexer 151-1 may output a third input value among the plurality of input values based on the value of the reference state selection signal BEN1 having the third value. Each of the first to third input values may be a reference current Iref, a reference voltage Vref, and a reference temperature Tref. The output of multiplexer 151-1 may be transferred to the comparator 152-1.

The comparator 152-1 may compare an input value from the column line CL1 with the output of the multiplexer 151-1. The input value of the comparator 152-1 may be output data of the battery corresponding to the first column of the activated row. The output data may include information about the current, voltage, or temperature of the battery. The comparator 152-1 may compare the reference value with the output data of the battery. When the reference state selection signal BEN1 has the first value, the comparator 152-1 may compare the reference current Iref with the current of the battery corresponding to the first column of the activated row. When the reference state selection signal BEN1 has the second value, the comparator 152-1 may compare the reference voltage Vref with the voltage of the battery. When the reference state selection signal BEN1 has the third value, the comparator 152-1 may compare the reference temperature Tref with the temperature of the battery. The temperature of the battery may be a surface temperature measured at the surface of the battery.

The determiner 153-1 may determine whether the state of the battery is normal based on the comparison result of the comparator 152-1. When the comparison result of the comparator 152-1 falls within a preset range, the determiner 153-1 may determine that the state of the battery is normal. When the comparison result is out of the preset range, the determiner 153-1 may determine that the state of the battery is abnormal. The determiner 153-1 may output a state determination result SER1 in which the state of the battery is determined to be normal or abnormal.

For example, a second row may be selected. The row selection signal RSG2 corresponding to the second row is applied to the row line RL2.

The row selection signal RSG2 turns on the row selection switches RSS21, RSS22, and RSS23 included in the control circuits 130-4, 130-5, and 130-6, respectively. Each of the output selection signals CEN21, CEN22, and CEN23 having the first selection value may be input to each of the multiplexers MUX21, MUX22, and MUX23. The output data of the batteries 110-4, 110-5, and 110-6 may be transferred to the state determination devices 150-1, 150-2, and 150-3 through the column lines CL1, CL2, and CL3, respectively.

The comparators 152-1, 152-2, and 152-3 may compare the output of the multiplexer 151-1, 151-2, and 151-3 with the output data of the batteries 110-4, 110-5, and 110-6 determined by the reference state selection signals BEN1, BEN2, and BEN3, respectively.

Each of the determiners 153-1, 153-2, 153-3 may determine the state of each of the batteries 110-4, 110-5, 110-6 based on a comparison result of each of the comparators 152-1, 152-2, 152-3. The determiners 153-1, 153-2, and 153-3 may provide the state determination results SER1, SER2, and SER3 including the states of the batteries 110-4, 110-5, and 110-6 to the system controller 140 of FIG. 1. Accordingly, the states of the batteries 110-4, 110-5, 110-6 corresponding to the second row can be detected.

The system controller 140 may output the first balancing control signals ABEN_C21, ABEN_C22, and ABEN_C23, the second balancing control signals ABEN_CN21, ABEN_CN22, and ABEN_CN23, and the third balancing control signals ABEN_DS21, ABEN_DS22, and ABEN_DS23 for performing balancing on the batteries 110-4, 110-5, and 110-6 based on the states of the batteries 110-4 and 110-5.

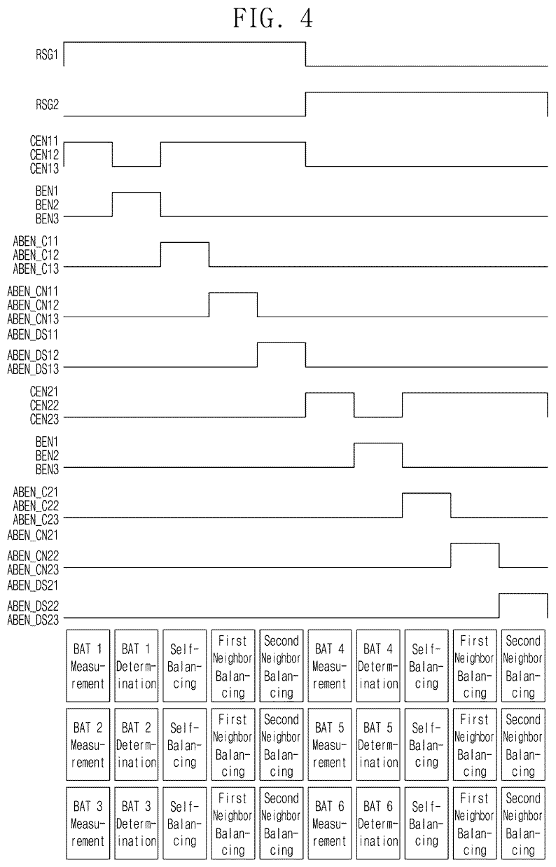

FIG. 4 is a timing diagram regarding signals of the battery balancing system according to an embodiment of the present disclosure.

Referring to FIGS. 3 and 4, the row selection signal RSG1 may be activated. In this case, the cell selection signals CEN11, CEN12, and CEN13 may have a first selection value. At this time, output data of the batteries 110-1, 110-2, and 110-3 are transferred to the column lines CL1, CL2, and CL3 through the turned-on row selection transistors RSS11, RSS12, and RSS13, respectively. The comparators 152-1, 152-2, 152-3 may obtain information about the batteries 110-1, 110-2, 110-3. Measurements of batteries 110-1, 110-2, and 110-3 are performed.

The cell selection signals CEN11, CEN12, and CEN13 may be deactivated, and the reference state selection signals BEN1, BEN2, and BEN3 may be activated. At this time, the outputs of the multiplexers 151-1, 151-2, and 151-3 may be determined according to the values of the reference state selection signals BEN1, BEN2, and BEN3. The comparators 152-1, 152-2, 152-3 may compare the output of the multiplexers 151-1, 151-2, 151-3 with the output data of the batteries 110-1, 110-2, 110-3. The comparators 152-1, 152-2, and 152-3 may compare the current, voltage, and temperature values received from the batteries 110-1, 110-2, and 110-3 with reference values received from the system controller 140. The determiners 153-1, 153-2, and 153-3 may generate and output the state determination results SER1, SER2, and SER3 based on the comparison result. Each of the state determination results SER1, SER2, and SER3 may indicate whether the state of the batteries 110-1, 110-2, and 110-3 is normal or abnormal. Determinations for the states of the batteries 110-1, 110-2, and 110-3 are performed.

When it is determined that the state of at least one of the batteries 110-1, 110-2, and 110-3 is abnormal, the cell selection signals CEN11, CEN12, and CEN13 may be activated to the second selection value, and the first balancing control signals ABEN_C11, ABEN_C12, and ABEN_C13 may be activated. As the first balancing control signals ABEN_C11, ABEN_C12, and ABEN_C13 are activated, self-balancing may be performed. The self-balancing refers to balancing which is performed between a corresponding battery and a corresponding balancing device. When the cell selection signals CEN11, CEN12, and CEN13 are activated to the second selection value, and the first balancing control signals ABEN_C11, ABEN_C12, and ABEN_C13 are activated, the B+ terminal of the battery 110-1 and the C+ terminal of the balancing device 120-1 may be connected, the B+ terminal of the battery 110-2 and the C+ terminal of the balancing device 120-2 may be connected, and the B+terminal of the battery 110-3 and the C+ terminal of the balancing device 120-3 may be connected. At this time, the balancing device 120-1 may perform balancing on the battery 110-1, the balance device 120-2 may perform balance on the battery 110-2, and the balancing device 120-3 may perform balancing on the battery 110-3.

Thereafter, the first balancing control signals ABEN_C11, ABEN_C12, and ABEN_C13 may be deactivated, and the second balancing control signal ABEN_CN11, ABEN_CN12, and ABENT_CN13 may be activated. As the second balancing control signals ABEN_CN11, ABEN_CN12, and ABEN_ CN13 are activated, first adjacent balancing may be performed. The first adjacent balancing refers to balancing which is performed between a corresponding battery and an adjacent balancing device. When the second balancing control signals ABEN_CN11, ABEN_CN12 and ABEN_CN13 are activated, the B+ terminal of the battery 110-1 and the C+ terminal of the balancing device 120-2 may be connected, the B+ terminal of the battery 110-2 and the C+ terminal of the balancing device 120-3 may be connected, and the B+ terminal of the battery 110-3 and C+ terminal of an adjacent balancing device (not shown) may be connected. In this case, the balancing device 120-2 may perform balancing on the battery 110-1, the balance device 120-3 may perform balancing on the battery 110-2, and the adjacent balancing device (not shown) may perform balancing on the battery 110-3.

Thereafter, the second balancing control signals ABEN_CN11, ABEN_CN12, and ABEN_CN13 may be deactivated, and the third balancing control signal ABEN_DS11, ABEN_DS12, and ABEN_DS13 may be activated. As the third balancing control signals ABEN_DS11, ABEN_DS12, and ABEN_DS13 are activated, second adjacent balancing may be performed. The second adjacent balancing refers to balancing which is performed between an adjacent battery and a corresponding balancing device. When the third balancing control signals ABEN_DS11, ABEN_DS12, and ABEN_DS13 are activated, the B+ terminal of the battery 110-2 and the C+ terminal of the balancing device 120-1 may be connected, the B+ terminal of the battery 110-3 and the C+ terminal of the balancing device 120-2 may be connected, and the B+ terminal of an adjacent battery (not shown) and the C+ terminal of the balancing device 120-3 may be connected. In this case, the balancing device 120-1 may perform balancing on the battery 110-2, the balance device 120-2 may perform balancing on the battery 110-3, and the balancing devices 120-3 may perform balancing on the adjacent battery (not shown).

After the balancing on the first row has ended, the next row may be selected. The row selection signal RSG1 may be deactivated, and the row selection signal RGS2 corresponding to the second row may be activated. In this case, the cell selection signals CEN21, CEN22, and CEN23 may have the first selection value. At this time, output data of the batteries 110-4, 110-5, and 110-6 are transferred to the column lines CL1, CL2, and CL3 through the turned-on row selection transistors RSS21, RSS22, and RSS23. The comparators 152-1, 152-2, 152-3 may obtain information about the batteries 110-4, 110-5, 110-6. Measurements of batteries 110-4, 110-5, and 110-6 are performed.

The cell selection signals CEN21, CEN22, and CEN23 may be deactivated, and the reference state selection signals BEN1, BEN2, and BEN3 may be activated. In this case, the output of the multiplexers 151-1, 151-2, and 151-3 may be determined according to values of the reference state selection signals BEN1, BEN2, and BEN3. The comparators 152-1, 152-2, 152-3 may compare the output of the multiplexers 151-1, 151-2, 151-3 with the output data of the batteries 110-4, 110-5, 110-6. The comparators 152-1, 152-2, and 152-3 may compare the current, voltage, and temperature values received from the batteries 110-4, 110-5, and 110-6 with reference values received from the system controller 140. The determiners 153-1, 153-2, and 153-3 may generate and output the state determination results SER1, SER2, and SER3 based on the comparison result. Each of the state determination results SER1, SER2, and SER3 may indicate whether the states of the batteries 110-4, 110-5, and 110-6 is normal or abnormal. Determinations for the states of batteries 110-4, 110-5, and 110-6 are performed.

When it is determined that the state of at least one of the batteries 110-4, 110-5, and 110-6 is abnormal, the cell selection signals CEN21, CEN22, and CEN23 may be activated to the second selection value, and the first balancing control signals ABEN_C21, ABEN_C22, and ABEN_C23 may be activated. As the first balancing control signals ABEN_C21, ABEN_C22, and ABEN_C23 are activated, self-balancing may be performed. When the cell selection signals CEN21, CEN22, and CEN23 are activated to the second selection value, and the first balancing control signals ABEN_C21, ABEN_C22, and ABEN_23 are activated, the B+ terminal of the battery 110-4 and the C+ terminal of the balancing device 120-4 may be connected, the B+ terminal of the battery 110-5 and the C+ terminal of the balancing device 120-5 may be connected, and the B+ terminal of the battery 110-6 and the C+ terminal of the balancing device 120-6 may be connected. At this time, the balancing device 120-4 may perform balancing on the battery 110-4, the balance device 120-5 may perform balancing on the battery 110-5, and the balancing devices 120-6 may perform balancing on the battery 110-6.

Thereafter, the first balancing control signals ABEN_C21, ABEN_C22, and ABEN_C23 may be deactivated, and the second balancing control signal ABEN_CN21, ABEN_CN22, and ABENT_CN23 may be activated. As the second balancing control signals (ABEN_CN21, ABEN_CN22, ABEN_ CN23) are activated, first adjacent balancing may be performed. When the second balancing control signals (ABEN_CN21, ABEN_CN22, ABEN_CN23) are activated, the B+ terminal of the battery 110-4 and the C+ terminal of the balancing device 120-5 may be connected, the B+ terminal of the battery 110-5 and the C+ terminal of the balancing device 120-6 may be connected, and the B+ terminal of the battery 110-6 and C+ terminal of an adjacent balancing device (not shown) may be connected. At this time, the balancing device 120-5 may perform balancing on the battery 110-4, the balance device 120-3 may perform balancing on the battery 110-5, and the adjacent balancing device (not shown) may perform balancing on the battery 110-3.

Thereafter, the second balancing control signals ABEN_CN21, ABEN_CN22, and ABEN_CN23 may be deactivated, and the third balancing control signal ABEN_DS21, ABEN_DS22, and ABEN_DS23 may be activated. As the third balancing control signals ABEN_DS21, ABEN_DS22, and ABEN_DS23 are activated, second adjacent balancing may be performed. When the third balancing control signals ABEN_DS21, ABEN_DS22, and ABEN_DS23 are activated, the B+ terminal of the battery 110-5 and the C+ terminal of the balancing device 120-4 may be connected, the B+ terminal of the battery 110-6 and the C+ terminal of the balancing device 120-5 may be connected, and the B+ terminal of an adjacent battery (not shown) and the C+ terminal of the balancing device 120-6 may be connected. At this time, the balancing device 120-4 may perform balancing on the battery 110-5, the balance device 120-5 may perform balancing on the battery 110-6, and the balancing devices 120-6 may perform balancing on the adjacent battery (not shown).

On the other hand, when the state of the batteries 110-1, 110-2, and 110-3 is determined to be normal, the balancing operation on the batteries 110-1 and 110-2 and 110-3 may be skipped. If the state of the batteries 110-4, 110-5, and 110-6 is determined to be normal, the balancing operation on the batteries 110-4 and 110-5 may be skipped.

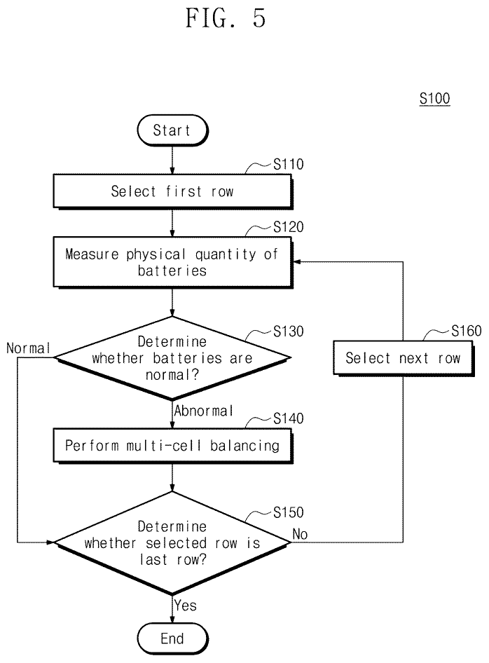

FIG. 5 is a flowchart illustrating an operating method of the battery balancing system according to an embodiment of the present disclosure.

Referring to FIG. 5, an operating method S100 of the battery balancing system 100 may include a step S110 selecting a first row.

Since the first row is selected in step S110, the row selection signal RSG1 corresponding to the first row may be output.

The operating method S100 of the battery balancing system 100 may include a step S120 measuring physical quantities of batteries corresponding to the selected row.

In step S120, the physical quantities of the batteries, for example, a surface temperature, a current, and a voltage of the battery, may be measured by sensors provided in the plurality of batteries. The physical quantities measured in the selected row may be provided to the state determination devices. For example, output data including the current, voltage, and surface temperature of the batteries measured in the selected row may be provided to the state determination devices.

The operating method S100 of the battery balancing system 100 may include a step S130 determining whether the batteries corresponding to the selected row are normal based on the physical quantities and reference values of the batteries corresponding to the selected row.

Step S130 may be performed by the state determination devices. The state determination devices may send the state determination result SER to the system controller 140. The control circuits may transmit the output data including the physical quantities of the batteries to the comparators in response to the output selection signal. The comparators may compare the measured physical quantities to the reference values. The determiner may output a state determination result based on the comparison result.

The operating method S100 of the battery balancing system 100 may include a step S140 performing multi-cell balancing based on which at least one of the batteries corresponding to the selected row is determined to be abnormal (S130—Abnormal). When all of the batteries corresponding to the selected row are determined to be normal (S130—Normal), the step S140 may be skipped.

Step S140 may include performing self-balancing, performing first adjacent balancing, and performing second adjacent balancing. The self-balancing, the first adjacent balancing, and the second adjacent balancing may proceed through the activation of the balancing control signals described in FIG. 4.

The operating method S100 of the battery balancing system 100 may include a step S150 determining whether the selected row is the last row.

The operating method S100 of the battery balancing system 100 may include a step S160 selecting a next row when it is determined that the selected row is not the last row (S150—No). After step S160, step S120 may be performed.

When the selected row is determined to be the last row (S150—Yes), the operating method S100 of the battery balancing system 100 may be terminated.

The battery balancing device according to the embodiment of the present disclosure may perform the self-balancing as well as the balancing with the adjacent balancing device or the adjacent battery through the first to third balancing control signals. This makes it possible to reduce the time required for the balancing and to ensure the possibility of expansion of the battery pack.

The foregoing is specific embodiments for carrying out the present disclosure. The present disclosure will include not only the embodiments described above, but also embodiments that can be simply changed in design or easily changed. In addition, the present disclosure will include techniques that can be easily modified and implemented by using embodiments. Therefore, the scope of the present disclosure should not be limited to the above-described embodiments, but should be defined by the following claims as well as those equivalent to the claims of the present disclosure.

The battery balancing system according to an embodiment of the present disclosure can reduce the time required for the battery balancing through the multi-cell balancing.

What is claimed is:

1. A battery balancing system comprising:
a battery pack block including a plurality of batteries corresponding to a plurality of rows and a plurality of columns;
a balancing block including a plurality of balancing devices, each of the plurality of balancing devices corresponding to each of the plurality of batteries, and performing balancing for a connected battery among the plurality of batteries;
a balancing control block including a plurality of control circuits, each of the plurality of control circuits corresponding to each of the plurality of batteries and each of the plurality of balancing devices, each of the control circuits connecting the corresponding battery and the corresponding balancing device in response to a first balancing control signal, connecting the corresponding battery and an adjacent balancing device in response to a second balancing control signal, and connecting an adjacent battery and the corresponding balancing device in response to a third balancing control signal;
a battery state determination block including a plurality of state determination devices, each of the state determination devices corresponding to each of the plurality of columns and generating a state determination result based on an output signal of the corresponding column; and
a system controller configured to activate a selected row among the plurality of rows and output the first to third balancing control signals corresponding to each of the plurality of batteries based on the state determination result,
wherein the adjacent balancing device corresponds to the same row as the corresponding battery and corresponds to an adjacent column, and the adjacent battery device corresponds to the same row as the corresponding battery and corresponds to an adjacent column.

2. The battery balancing system of claim 1,
wherein each of the plurality of control circuits is configured to connect the corresponding battery and the battery state determination block or the balancing block in response to an output selection signal.

3. The battery balancing system of claim 2,
wherein each of the plurality of control circuits comprises:
a multiplexer configured to receive an input from the corresponding battery and output the input to either a first output or a second output in response to the output selection signal;
a row selection switch configured to connect the first output and the corresponding battery state determination device and to be turned on in response to a row selection signal;
a first balancing switch configured to connect the corresponding balancing device and the second output and to be turned on in response to the first balancing control signal;
a second balancing switch configured to connect the adjacent balancing device and the second output and to be turned on in response to the second balancing control signal; and
a third balancing switch configured to connect the corresponding balancing device and a second output of an adjacent multiplexer and to be turned on in response to the third balancing control signal.

4. The battery balancing system of claim 1,
wherein each of the plurality of state determination devices comprises:
a multiplexer configured to select and output one of a plurality of reference values in response to a reference selection signal;
a comparator configured to compare the output signal of the corresponding column with an output of the multiplexer; and
a determiner configured to determine a state of the battery based on an output of the comparator.

5. The battery balancing system of claim 4,
wherein the plurality of reference values comprises at least one of a reference current, a reference voltage, or a reference temperature.

6. The battery balancing system of claim 1,
wherein the system controller is configured to,
receive the state determination result for the selected row,
perform multi-cell balancing in response to the state determination result being abnormal,
deactivate the selected row, and
activate a next row following the selected row.

7. The battery balancing system of claim 6,
wherein the system controller, when performing the multi-cell balancing, is configured to activate the first balancing control signal for the selected row, deactivate the first balancing control signal, then activate the second balancing control signal, deactivate the second balancing control signal, and then activate the third balancing control signal.

8. The battery balancing system of claim 1,
wherein the system controller is configured to,
perform parallel balancing by activating the first balancing control signal for the selected row,
receive the state determination result for the selected row, and
in response to the state determination result being abnormal, activate the second balancing control signal, deactivate the second balancing control signal, and activate the third balancing control signal.

9. A method of operating a battery balancing system comprising a plurality of batteries corresponding to a plurality of rows and a plurality of columns, the method comprising:
selecting a first row as a target row from among the plurality of rows;
measuring physical quantities of batteries corresponding to the target row;
determining whether the batteries corresponding to the target row are normal or abnormal, based on the physical quantities of the batteries and reference values;
performing multi-cell balancing based on whether one or more of the batteries corresponding to the target row are abnormal;
determining whether the target row is a last row; and
selecting a next row as the target row in response to the determination that the target row is not the last row,
wherein performing the multi-cell balancing comprises:
performing self-balancing;
performing first adjacent balancing; and
performing second adjacent balancing.

10. The method of claim 9,
wherein in performing the self-balancing, a balancing device corresponding to a first control circuit performs balancing for a battery device corresponding to the first control circuit;
in performing the first adjacent balancing, a balancing device adjacent to the first control circuit performs balancing for a battery device corresponding to the first control circuit; and
in performing the second adjacent balancing, the balancing device corresponding to the first control circuit performs balancing for a battery device adjacent to the control circuit.

11. The method of claim 9,
wherein determining whether the batteries corresponding to the target row are normal or abnormal comprises:
activating an output selection signal to a first selection value;
comparing the measured physical quantities with the reference values and outputting a comparison result; and
outputting a state determination result based on the comparison result.
